(19) United States
(12) Patent Application Publication
(10) Pub. No.: US 2016/0088228 A1
(43) Pub. Date: Mar. 24, 2016

(54) PHOTOGRAPH METHOD AND PHOTOGRAPH DEVICE

(71) Applicant: HON HAI PRECISION INDUSTRY CO., LTD., New Taipei (TW)

(72) Inventor: PING-CHU TSAI, New Taipei (TW)

(21) Appl. No.: 14/750,218

(22) Filed: Jun. 25, 2015

(30) Foreign Application Priority Data
Sep. 23, 2014 (TW) 103132732

(51) Int. Cl. H04N 5/232; H04N 5/235

(52) U.S. Cl. CPC H04N 5/23293; H04N 5/2351; H04N 5/23225

(57) ABSTRACT

A photographing method is provided. The method includes: displaying, in a display of an electronic device, a preview of an object to be photographed; generating at the electronic device, in response to a user input, a brightness control command; modifying, at the electronic device, a current brightness of the display in response to the brightness control command; and photographing, at the electronic device, the object.

### FIELD

The subject matter herein generally relates to a method and a device for photographing, especially relates to a method and a device for photographing using a front camera.

### BACKGROUND

Many electronic devices, for example, smart phones, tablet PCs, are equipped with both a front camera and a rear camera. Most of the front cameras are not equipped with flash, so that the photo taken by the front camera in dark might be unsatisfactory.

### BRIEF DESCRIPTION OF THE DRAWINGS

Implementations of the present technology will now be described, by way of example only, with reference to the attached figures.

FIG. 1 is a diagrammatic view of an exemplary embodiment of an electronic device.

FIG. 2 is block diagram of an exemplary embodiment of an electronic device.

FIG. 3 is a flowchart of an exemplary embodiment of a photographing method.

FIG. 4 is a diagrammatic view of an exemplary embodiment of an electronic device under a photographing state.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

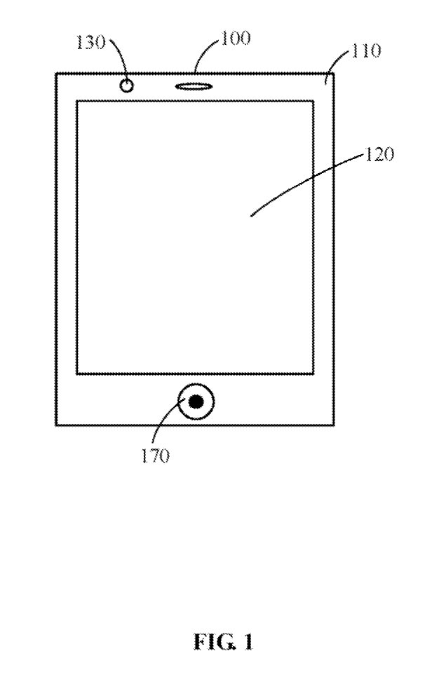

FIG. 1 illustrates a diagrammatic view of an exemplary embodiment of an electronic device 100. In the exemplary embodiment, the electronic device 100 can be a smart phone, a tablet PC, or other portable electronic device having a front camera. The electronic device 100 can include, but not limited to, a housing 110, a display 120, and a camera 130. The camera 130 is arranged at the same side of the housing 110 with the display 120 and can be known as a front camera. The display 120 can be a liquid crystal display or other currently available display. In at least one embodiment, the display can be a touch screen display.

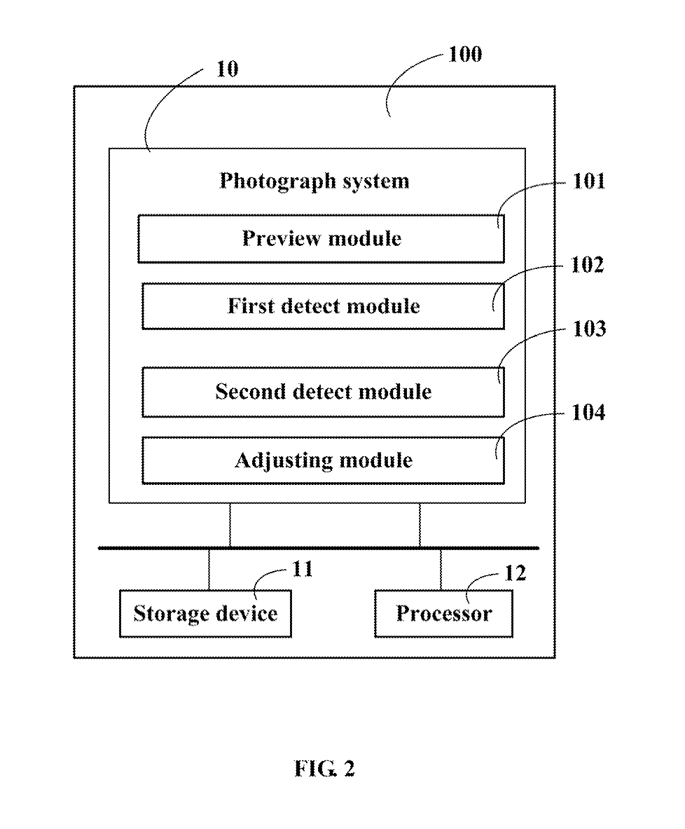

Referring to FIG. 2, a block diagram of an exemplary embodiment of an electronic device 100 is illustrated. In the exemplary embodiment, the electronic device 100 can include a storage device 11 and a processor 12. The storage device 11 can be configured to store data related to operation of the electronic device 100. The processor 12 can be configured to control operation of the electronic device 100.

The storage device 11 can be an internal storage unit of the electronic device 100, for example, a hard disk or memory, or a pluggable memory, for example, Smart Media Card, Secure Digital Card, Flash Card. In at least one embodiment, the storage device 11 can include two or more storage devices such that one storage device is an internal storage unit and the other storage device is a pluggable memory. The processor 12 can be a central processing unit (CPU), a microprocessor, or other data processor chip that performs functions of the electronic device 100.

A photographing system 10 can include computerized instructions in the form of one or more programs that can be stored in the storage device 11 and executed by the processor 12. In the embodiment, the photographing system 10 can be integrated in the processor 12. In at least one embodiment, the photographing system 10 can be independent from the processor 12. Referring to FIG. 2, the system 10 can include one or more modules, for example, a preview module 101, a first detect module 102, a second detect module 103, and an adjust module 104. A “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The preview module 101 can be configured to display a preview of the object to be photographed by the camera 130 on the display 120.

The first detect module 102 can be configured to detect user input and to generate a brightness control command in response to the detected user input.

The second detect module 103 can be configured to detect user input and to generate a color temperature control command in response to the detected user input.

The modify module 104 can be configured to modify current brightness and/or color temperature of the display 120 based on the output of the first detect module 102 and/or the second detect module 103.

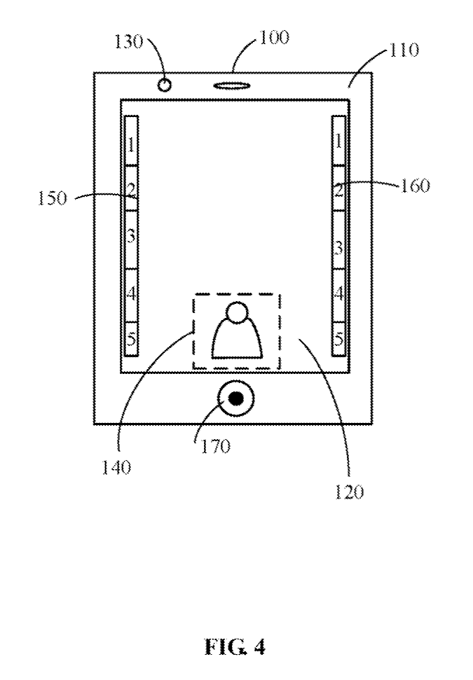

In at least one embodiment, referring to FIG. 1 and FIG. 4, the electronic device 100 can include a brightness detect unit 170 configured to detect current ambient brightness of the electronic device and the electronic device 100 can modify current brightness of the display based on the current ambient brightness. For example, when the current ambient brightness is lower than a predefined value, the electronic device can enhance current brightness of the display.

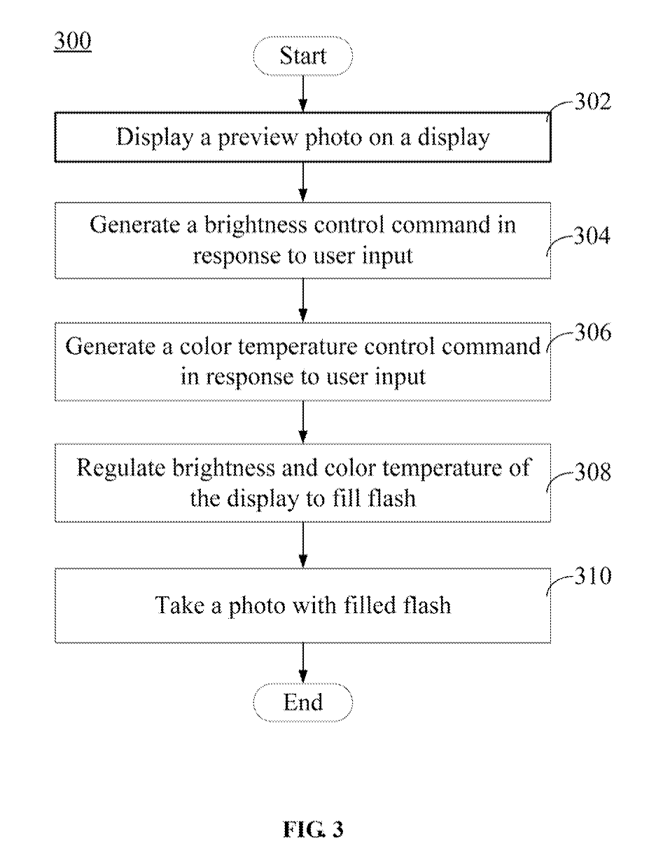

Referring to FIG. 3, a flowchart is presented in accordance with an example embodiment which is being thus illustrated. The example method 300 is provided by way of example, as there are a variety of ways to carry out the method. The method 300 described below can be carried out using the configurations illustrated in FIGS. 1 and 2, for example, and various elements of the figure is referenced in explaining example method 300. Each block shown in FIG. 3 represents one or more processes, methods or subroutines, carried out in the exemplary method 300. Furthermore, the illustrated order of blocks is by example only and the order of the blocks can change according to the present disclosure. Additional blocks may be added or fewer blocks may be utilized, without departing from this disclosure. The exemplary photographing method 300 is illustrated in FIG. 3. The exemplary method 300 can be executed by an electronic device, and can begin at block 302. The electronic device can include a storage device configured to store related information, a display for displaying a preview of an object to be shot, and a camera arranged at a same side of the electronic device with the display and configured for photographing the object to be shot.

At block 302, the electronic device displays a preview of an object to be photographed on the display when the camera is activated. Referring to FIG. 4, in an exemplary embodiment, the preview can be displayed in a preview window 140 which can be arranged close to the bottom of the display. In at least one embodiment, the preview window 140 can be arranged at any suitable portion of the display, for example, center of the display, or upper portion of the display.

At block 304, the electronic device detects user input and generates a brightness control command in response to the user input. Referring to FIG. 4, in the exemplary embodiment, the display can be a touch screen display, and the electronic device can display a brightness state bar 150 configured to indicate a brightness value of the photo displayed on the display. In the exemplary embodiment, the brightness state bar 150 can be arranged at a left side of the display. In at least one embodiment, the brightness state bar 150 can be arranged at any suitable portion of the display that is not overlapped with the preview window 140, for example, an upper portion of the display, a bottom portion of the display, or a right portion of the display. The brightness state bar 150 can have five levels. Each level can indicate a range of brightness values. In one exemplary embodiment, each level can be associated with duration of pressures applied on the brightness state bar 150, and the brightness of the display can be modified along with the changes of the duration of the pressures applied on the brightness state bar 150. In at least one exemplary embodiment, each level can indicate a specific brightness value, and a user can click the position where one of the five levels is located to select the level, therefore, the brightness of the display can be modified along with the click of the user.

At block 306, the electronic device detects user input and generates a color temperature control command in response to the user input. The color temperature can be modified in a similar way as the brightness. A similar color temperature state bar 160 can be used to indicate a color temperature value of the display. In the exemplary embodiment, the color temperature state bar 160 can be arranged at a right side of the display. In at least one embodiment, the color temperature state bar 160 can be arranged at any suitable portion of the display that is not overlapped with the preview window 140 and the brightness bar 150, for example, an upper portion of the display, a bottom portion of the display, or a right portion of the display. In the same way, the color temperature of the display can be modified in response to pressure applied on the temperature state bar 160 or click on one of the five levels corresponding to a specific color temperature value.

At block 308, the electronic device modifies the brightness and the color temperature of the display so as to fill flash.

At block 310, the electronic device photographs the object under the filled flash.

In at least one embodiment, the electronic device can include a brightness detect unit configured to detect current ambient brightness. The method 300 can further include detecting current ambient brightness and modifying current brightness of the display based on the detected current ambient brightness. For example, when the current ambient brightness is lower than a predefined value, the electronic device can modify current brightness of the display to be a higher value.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method comprising:
displaying, in a display of an electronic device, a preview of an object to be photographed;
generating at the electronic device, in response to a user input, a brightness control command;
modifying, at the electronic device, a current brightness of the display in response to the brightness control command; and
photographing, at the electronic device, the object.

2. The method according to claim 1, further comprising:
detecting, at the electronic device, a current ambient brightness; and
modifying, at the electronic device, the current brightness of the display based on the current ambient brightness.

3. The method according to claim 1, further comprising:
displaying, at the electronic device, a brightness bar, wherein the brightness bar includes at least two levels, each level indicating a brightness value range; and
modifying, at the electronic device, the current brightness of the display in response to a selection of one of the at least two levels.

4. The method according to claim 1, further comprising:
displaying, at the electronic device, a brightness bar, wherein the brightness bar includes at least two levels, each level indicating a brightness value range; and
modifying, at the electronic device, the current brightness of the display in response to a duration of pressure applied on the brightness bar.

5. The method according to claim 1, further comprising:
generating on the display of the electronic device, a color temperature control command in response to a user input; and
modifying, at the electronic device, a current color temperature of the display in response to the color temperature control command.

6. The method according to claim 5, further comprising:
displaying, at the electronic device, a color temperature bar, wherein the color temperature bar includes at least two levels, each level indicating a color temperature value range; and
modifying, at the electronic device, the current color temperature of the display in response to a selection one of the at least two levels.

7. The method according to claim 5, further comprising:
displaying, at the electronic device, a color temperature bar, wherein the color temperature bar includes at least two levels, each level indicating a color temperature value range; and
modifying, at the electronic device, the current color temperature of the display in response to a duration of pressure applied on the color temperature bar.

8. An electronic device, comprising:
a display;
a camera;
a storage device configured to store instructions; and
a processor configured to execute instructions to cause the processor to:
display a preview of an object to be photographed;
generate a brightness control command in response to a user input;
modify current brightness of the display in response to the brightness control command; and
photograph the object.

9. The electronic device according to claim 8, wherein the instructions further cause the processor to:
detect a current ambient brightness; and
modify the current brightness of the display based on the current ambient brightness.

10. The electronic device according to claim 8, wherein the instructions further cause the processor to:
display a brightness bar, wherein the brightness bar includes at least two levels, each level indicating a brightness value range; and
modify the current brightness of the display in response to a selection of one of the at least two levels.

11. The electronic device according to claim 8, wherein the instructions further cause the processor to:
display a brightness bar, wherein the brightness bar includes at least two levels, each level indicating a brightness value range; and
modify the current brightness of the display in response to duration of pressure applied on the brightness bar.

12. The electronic device according to claim 8, wherein the instructions further cause the processor to:
generate a color temperature control command in response to a user input; and
modify current color temperature of the display in response to the color temperature control command.

13. The electronic device according to claim 12, wherein the instructions further cause the processor to:
display a color temperature bar, wherein the color temperature bar includes at least two levels, each level indicating a color temperature value range; and
modify the current color temperature of the display in response to a selection of one of the at least two levels.

14. The electronic device according to claim 12, wherein the instructions further cause the processor to:
display a color temperature bar, wherein the color temperature bar includes at least two levels, each level indicating a color temperature value range; and
modify the current color temperature of the display in response to a duration of pressure applied on the color temperature bar.
